(19) United States
(12) Patent Application Publication
(10) Pub. No.: US 2002/0066107 A1
(43) Pub. Date: May 30, 2002

(54) Multimedia information utilizing method and apparatus

(76) Inventor: Mei Kodama, Hiroshima (JP)

Correspondence Address: WELLS ST. JOHN P.S., 601 W. FIRST, SUITE 1300, SPOKANE, WA, 99201-3828, US

(21) Appl. No.: 10/007,611

(22) Filed: Nov. 9, 2001

(30) Foreign Application Priority Data
Nov. 10, 2000 (JP) 2000-344534
Nov. 7, 2001 (JP) 2001-341562

(51) Int. Cl. H04N 7/173; H04N 7/16

(52) U.S. Cl. 725/87; 725/135; 725/1

(57) ABSTRACT

The multimedia information processing device includes an internal structural information generator for generating the internal structural information by analyzing the internal structure of the content information, and an operation process information generator for generating operation process information by analyzing the content information. The content information, the internal structural information and the operation process information are unified so that they are processed unitarily. A partial data of the content information is reduced or deleted where the value of the content information becomes low, for example, and the content information a part of which has been reduced can be restored by obtaining the relevant partial data from the producer terminal, if necessary. The hardware resources at the user terminal side are effectively utilized.

### RELATED APPLICATIONS

This application relates to and claims priorities from corresponding Japanese Patent Application Nos. 2000-344534 filed on Nov. 10, 2000 and 2001-341562 filed on Nov. 7, 2001.

### BACKGROUND OF THE INVENTION

1. Field of the Invention

The present invention relates to an apparatus for utilizing multimedia information and, more particularly, to a method and an apparatus for searching the movie images wherein the utilization, storage and editing of the multimedia information as well as the fee payment for the utilization of the multimedia information can effectively be performed.

2. Description of the Related Art

Conventionally, the so-called content information including the still image, audio data, text data and the movie image is kept as it is, if it has been once recorded and there is no access thereon by the user. Therefore, with the increase in the content information under utilization, it would be necessary for the storage device to have a storage capacity to cope with the increased amount of information.

Since the content information produced has different importance for each producer and each user and further its importance usually changes with the lapse of time, in the conventional technique, it is impossible to store and utilize the information in accordance with its necessity, thereby preventing the limited hardware resources of the user side from being effectively used. For example, in the case where the content information was frequently used in the past but there is no utilization at all at the present, it is normal that such content information is now stored as it had been used in the past. In the conventional technique as above, it cannot be said that the storage device is effectively used if the value of the information is taken into consideration. Here, the content information refers to the digital multimedia information such as the text data, audio data, still image, movie image and map.

Further, in buying and selling the content information through and on the network in the conventional technique, it is possible to provide the user with the content information upon receipt of the fee payment only when the user purchases the information first but thereafter it is impossible to receive any fee every time the user utilizes the same content information.

Therefore, the principal object of the invention is to achieve the realization of the utility environment wherein only the necessary parts of the information can be utilized according to the user's requirements and wherein the variable features of the values of the information are used by unitarily treating the operation process information and the internal structural information with the content information which is produced into the layered structure and which is capable of being resolved into parts. The operation process information and the internal structural information are ones with the utilization environment about the content information such as the lapse of time, network environment, the processing ability of the terminal and the value of the same content information which changes from time to time being taken into consideration.

### SUMMARY OF THE INVENTION

According to the invention, the amount of the content information whose utilization value has become low is automatically reduced and, thereafter, in accordance with the necessity, the part of information which has been once reduced can be obtained again through the on-line network, whereby the relevant information can be restored. As a consequence, it is possible to effectively utilize the physically limited hardware resources at the user side.

The content information whose value becomes low can be automatically reduced or deleted, and such content information whose partial data has been once deleted can be restored, if desired, by newly obtaining the partial data which corresponds to the deleted partial data from the network. As a consequence, it has become possible to effectively utilize the limited hardware resources at the user side.

Further, with the method and apparatus according to the invention, in the selling and buying of the content information, the imposing of the fee to the user can be achieved not only when the user procures the content information at the first time but also every time when the user restores and utilizes the content information.

### BRIEF DESCRIPTION OF THE DRAWINGS

The above and other objects, features and advantages of the present invention will be apparent from the following description of preferred embodiments of the invention explained with reference to the accompanying drawings, in which:

FIG. 1 is a conceptional view of the data structure of the content information;

FIG. 2 is a diagram showing changes of the content information;

FIG. 3 is a block diagram showing a means for generating the content information;

FIG. 4 is a block diagram showing a means for reducing the partial data of the content information;

FIG. 5 is a block diagram showing another means for reducing the partial data of the content information;

FIG. 6 is a block diagram showing a means for restoring or adding the partial data of the content information;

FIG. 7 is a block diagram showing another means for restoring or adding the partial data of the content information;

FIG. 8 is a diagram showing the hardware construction according to the invention;

FIG. 9 is a block diagram showing the processing means according to the invention;

FIG. 10 is a flow-chart of the processing according to the invention;

FIG. 11 is a flow-chart showing the controlling of the data-base;

FIG. 12 is a diagram showing the system construction according to the invention;

FIG. 13 is a diagram showing the procedures for obtaining the content information from the information producer terminal;

FIG. 14 is a diagram showing the procedures for obtaining the content restoring information from the information producer terminal;

FIG. 15 is a block diagram showing a means for obtaining the content information;

FIG. 16 is a block diagram showing a means for obtaining the content restoring information;

FIG. 17 is a diagram showing another system construction according to the invention;

FIG. 18 is a diagram showing the procedures for registering the content information to the content information control terminal;

FIG. 19 is a block diagram showing a means for registering the content information to the content information control terminal;

FIG. 20 is a diagram showing the procedures for obtaining the content information from the content information control terminal;

FIG. 21 is a diagram showing the procedures for obtaining the content restoring information from the content information control terminal; and

FIG. 22 is a diagram showing the procedures for obtaining the partial data of the content information from the content information control terminal.

### PREFERRED EMBODIMENTS OF THE INVENTION

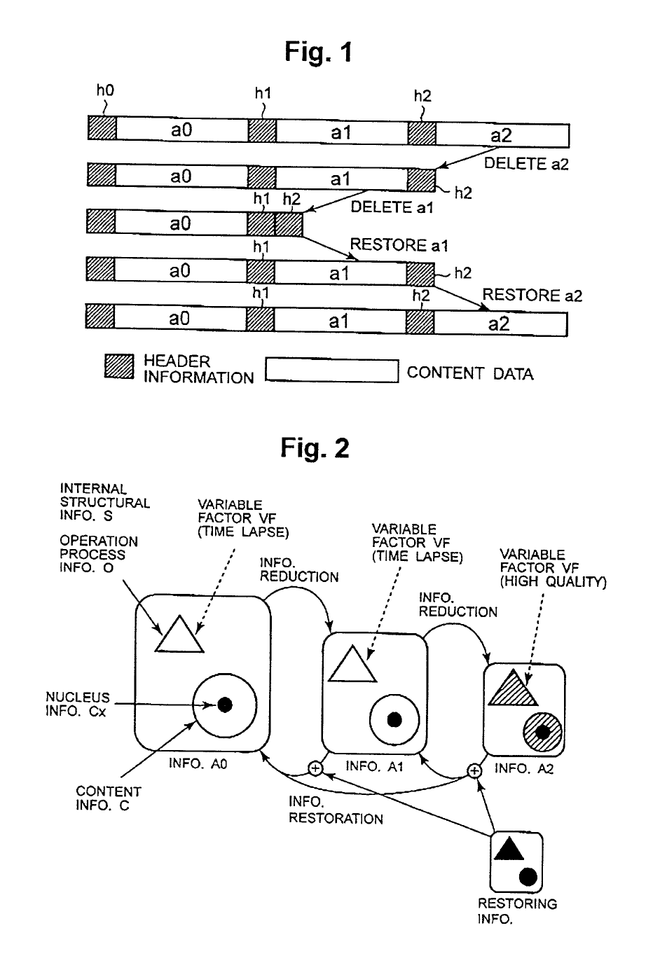

An exemplary data construction of the non-layered structure content information such as the still image, audio data, text data and movie image is schematically shown in FIG. 1. The content information used in the present invention comprises an information code (hereinafter referred to as a “header information”) which is for making the content data layer-structured and the content data which has been layer-structured.

In FIG. 1, the content data is shown such that it has been dividedly produced by three steps as the partial data a0-a2. Each of the partial data is accompanied by each of the header information h0-h2. In the case where the content information is reduced, the content data of the partial data a2, a1 are deleted. However, as the header information h2, h2 of the corresponding partial data is not deleted, the partial data once deleted can be restored, if necessary, based on the header information.

If the movie image information is taken as an example of the content information, it is possible to produce the content information with the various conditions such as the size of the image, the quality of the image, the length of the reproducing time being incorporated. Further, according to the invention, the content information can effectively be utilized by the deletion or restoration of the layer-structured partial data.

Next, with reference to FIG 2, the principle of the changes in the content information which is formed by the internal structural information, the operation process information and the layer-structured content data is explained.

According to the invention, with the unitarily treating of the content information C having the layered structure, the internal structural information S and the operation process information O, the utilization of information with the utilization environment and the value of information being taken into consideration is realized.

Here, the content information C having the layered structure is the content information wherein its quality and content, etc. are structured in a layer form. The internal structural information S is the information which represents the layer-structure of the layer-structured content information, the combination status of a plurality of non-layer structured content information or the combination status of the layer- and non-layer-structured content information. The operation process information is a parameter which is determined with the environments where the information is utilized are taken into consideration. The environment includes the lapse of time after the content information was produced, the load degree where the information is transmitted to other terminals through the network, etc., the load degree where the information is moved to the different media, and the differences between the abilities of the terminals using the information.

Further, the value of the information is a parameter which should be included in the operational information, namely, the operation process information O. The value of the information is a parameter which is determined with the value of the information that varies in accordance with the lapse of time, the value that is determined based on the utilization frequencies of the content information, or the subjective value such as the user's taste or preference being taken into consideration.

According to the invention, by unitarily treating the content information C, the internal structural information S and the operation process information O, there is realized the information variable type information process method and apparatus wherein the reduction and restoration of the partial data repeat based on the internal structural information S and the operation process information O. In this way, by unitarily processing the content information C having the layered-structure or in combination with the non-layer-structured content information, the internal structural information S and the operation process information O, the environments where the information is utilized and the changes in the information value become factors which cause the content information change. Here, such factors are called the variable factor VF.

The information for the variable factor VF may involve the lapse of time, the genre of the content information, the service class of the content information provided to the user, the designation from the user, the load of the system, the load of the network and the utilization frequency of the content information.

Further explanation is made with reference to FIG. 2. Assuming that the comprehensive information including the content information C, the internal structural information S and the operation process information O is the information A0, such content information changes to, for example, the information A1 with the part of the information being reduced based on such variable factor VF as the lapse of time. With the further lapse of time, the information changes to the information A2 with the amount of information being further reduced based on the same variable factor VF. The importance here is that, although the information amount of the content information changes, the core information Cx of the information does not change but only the redundancy of the information is reduced Therefore, if the user wishes to utilize the content information with higher quality, the content information A2 at the present stage is changed (restored) to the information A1 and further to the information A0 with the necessary partial data for restoration being added based on the corresponding variable factor VF

Further, it is not only the case where the amount of the content information is only increased or decreased but also the case where the resoluble content information can be combined with other content information based on such variable factor VF as the combination. In this way, according to the utilization environments of the content information and the value of the information from time to time, the content information can repeat the desired changes freely.

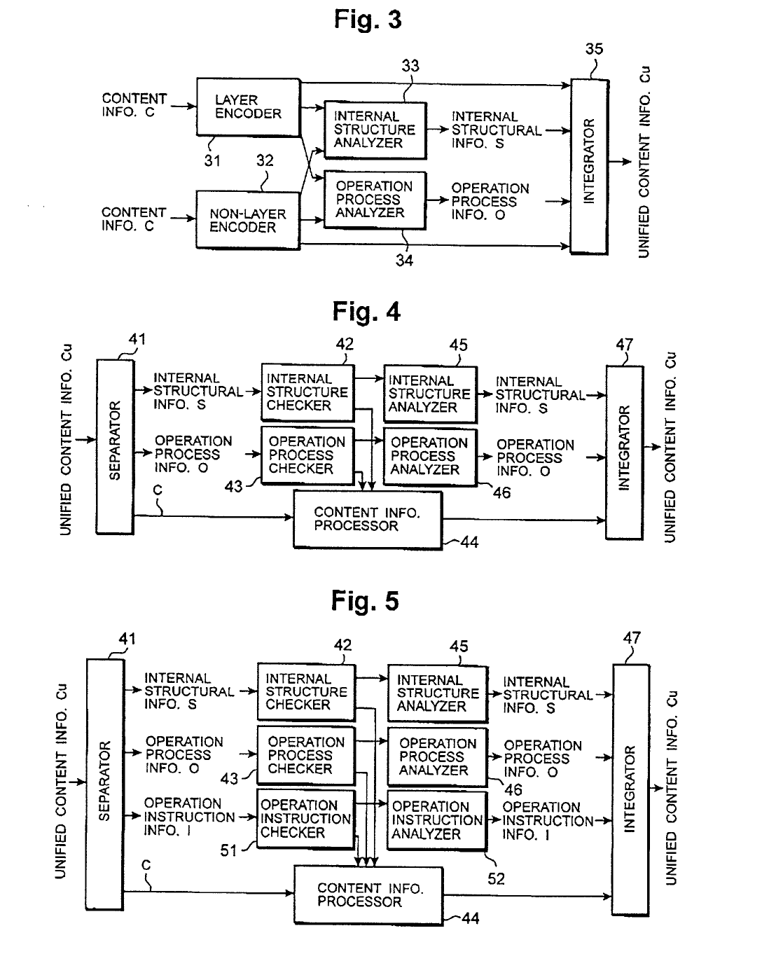

Next, with reference to FIG. 3, the procedures for generating the content information is explained.

In order to generate the content information which is used in the system of the invention, the content information C is inputted to a layer encoder 31 or a non-layer encoder 32, so that the content information having the layered-structure or the non-layered structure is produced. Then, the content information thus produced is inputted to an internal structure analyzer 33 where the layer-structure of the content information is analyzed and the internal structural information S is generated therefrom. The process information as to how the content information is processed, more specifically, the information concerning the lapse of time, the genre of content information, and the service class of the content information which is provided to the user is produced by an operation process analyzer 34 as the operation process information O. The above content information C, the internal structural information S and the operation process information O are integrated by an integrator 35 to produce a unified content information Cu so that they are unitarily treated.

Referring to FIG. 4, the procedures for reducing the partial data from the unified content information Cu is explained.

The unified content information Cu generated according to the procedures shown in FIG. 3 is separated by a separator 41 into the internal structural information S, the operation process information O and the content information C.

Then, an internal structure checker 42 obtains the data structure condition of the content information C based on the internal structural information S. An operation process checker 43 obtains, based on the operation process information O, the information as to how to operate the content information C, namely, as to what portion of the partial data is reduced. Based on the information thus obtained, a content information processor 44 reduces the partial data from the separated content information C.

Upon completion of the deletion or reduction process, the internal structural information S is updated by an internal structure analyzer 45 so that the changes in the content information are reflected. Also, the operation process information O is updated by an operation process analyzer 46. The above information is unified by an integrator 47 for the unification process.

Another procedure for deleting the partial data of the content information, according to the invention, is explained with reference to FIG. 5. In this procedure, in addition to the processes shown in FIG. 4, an operation instruction information I is further added. Other processes are the same as those in FIG. 4. Based on the operation instruction information I which is separated by the separator 41, an operation instruction checker 51 obtains an information relating to the operation instruction. Upon deletion of the partial data, the operation instruction information I is updated by an operation instruction analyzer 52.

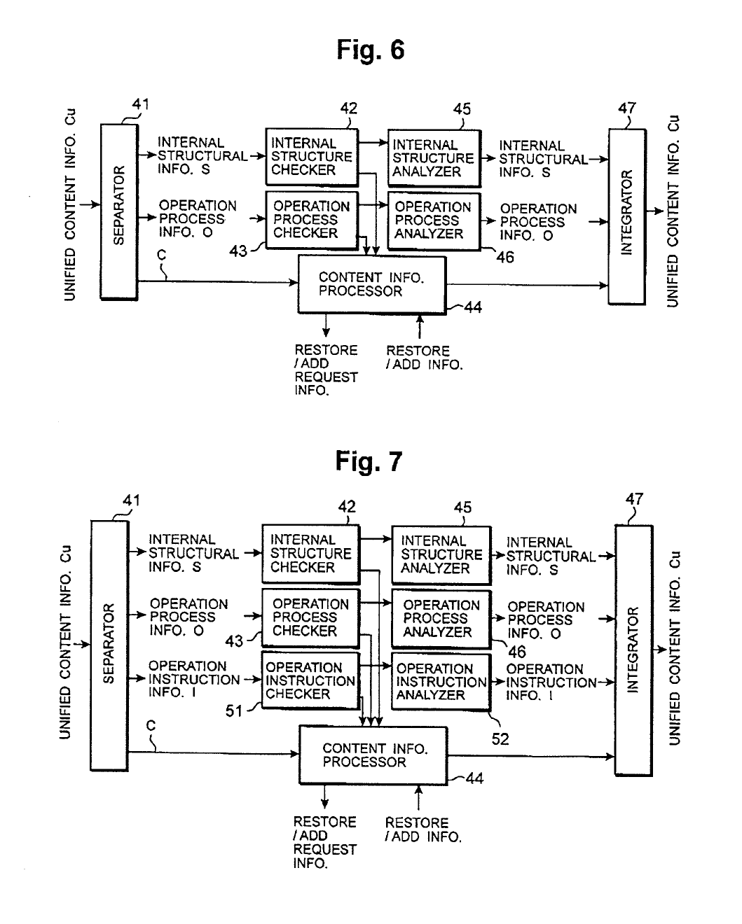

Referring to FIG. 6, the procedure for restoring or adding the partial data of the content information, according to the invention, is explained.

The unified content information Cu which is produced according to the processes shown in FIG. 3 is separated by the separator 41 into the internal structural information S, the operation process information O and the content information C.

Then, the internal structure checker 42 obtains the data structure condition of the content information C based on the internal structural information S. The operation process checker 43 obtains, based on the operation process information O, the information as to how to operate the content information C, namely, as to what portion of the partial data is restored or added. Based on the information thus obtained, the content information processor 44 requests the relevant partial data, which is necessary to restore the separated content information, to the data-base where the content information was stored as it was. The partial data which is necessary for the restoration or addition is obtained from the data-base and the content information is restored or added accordingly.

Upon completion of the restoration or addition process, the internal structural information S is updated by the internal structure analyzer 45 so that the changes in the content information are reflected. Also, the operation process information O is updated by the operation process analyzer 46. The above information is unified by the integrator 47 for the unification process.

Another procedure for restoring or adding the partial data of the content information, according to the invention, is explained with reference to FIG. 7. In this procedure, in addition to the processes shown in FIG. 6, the operation instruction information I is further added. Other processes are the same as those in FIG. 6. Based on the operation instruction information I which is separated by the separator 41, the operation instruction checker 51 obtains information relating to the operation instruction. Upon completion of the restoring or adding process, the operation instruction information I is updated by the operation instruction analyzer 52.

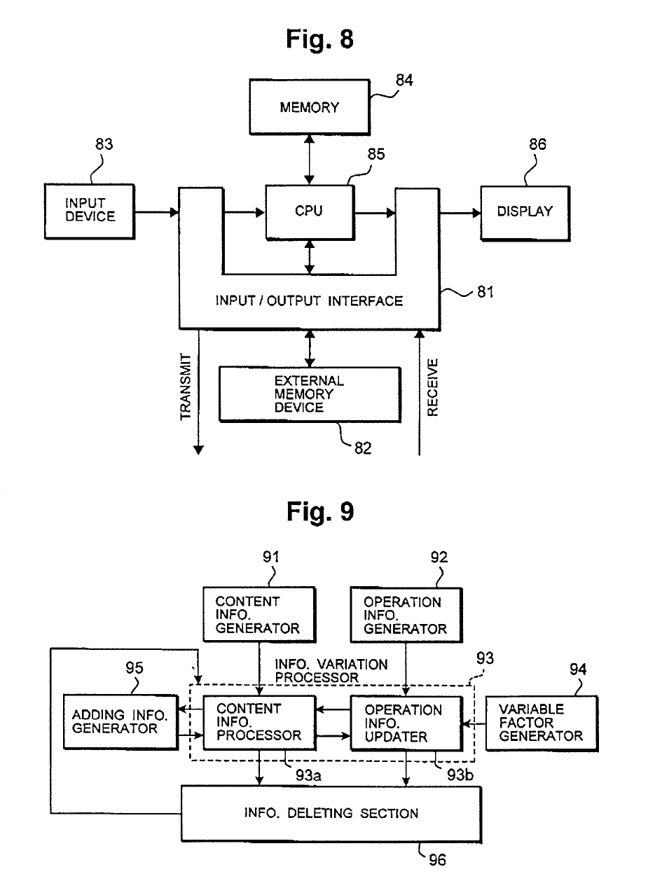

FIG. 8 shows an exemplary hardware construction of the content information producer terminal and the user terminal.

In the content information producer terminal, the content information which is stored in an external memory device 82 is specified by an input device 83 through an input/output interface 81. A central processing unit (CPU) 82 together with a memory 84 generates the unified content information Cu which is constituted by the content information C, the internal structural information S and the operation process information O. The above information can be confirmed on a display 86.

The unified content information Cu thus generated is transmitted to the external terminals through the input/output interface 81.

In a user terminal which has basically the same constitution as that of the content information producer terminal, mainly the CPU 85 and the memory 84 monitor the internal structural information S and the operation process information O in the received unified content information Cu and store the content information in the external memory device 82 with, if necessary, the partial data being deleted or restored. In the case where the restoring, combining or merging of the information is performed based on the request from the user side, such request is transmitted to the outside terminals through the input/output interface 81.

The hardware construction is not limitative to the one illustrated in FIG. 8. The necessary hardware can be constituted by using, for example, electric signal switching devices without using the CPU 85.

Next, the procedure according to the invention is explained with reference to FIG. 9. The unified content information used in the system of the invention is generated by a content information generator 91, while the operation information with respect to the content information is generated by an operation information generator 92.

To an information variation processor 93, the variable factor information generated in a variable factor generator 94 is inputted. The information variation processor 93 causes a content information processor 93a and an operation information updater 93b to operate. The content information processor 93a operates to delete the content information or to add the partial data by using an adding information generator 95. The operation information is updated by the operation information updater 93b in accordance with the changes in the content information.

The information outputted from both the processors is subjected to the deletion of its partial data by the information deletion section 96 if the content of the operation information includes the deletion information for the information. In the case where the user issues a request for deletion of the partial data of the information, in the same manner, the deletion process is performed by the information deleting section 96. In other cases than the above, the information is again inputted to the information variation processor 93 and the same processes are repeated.

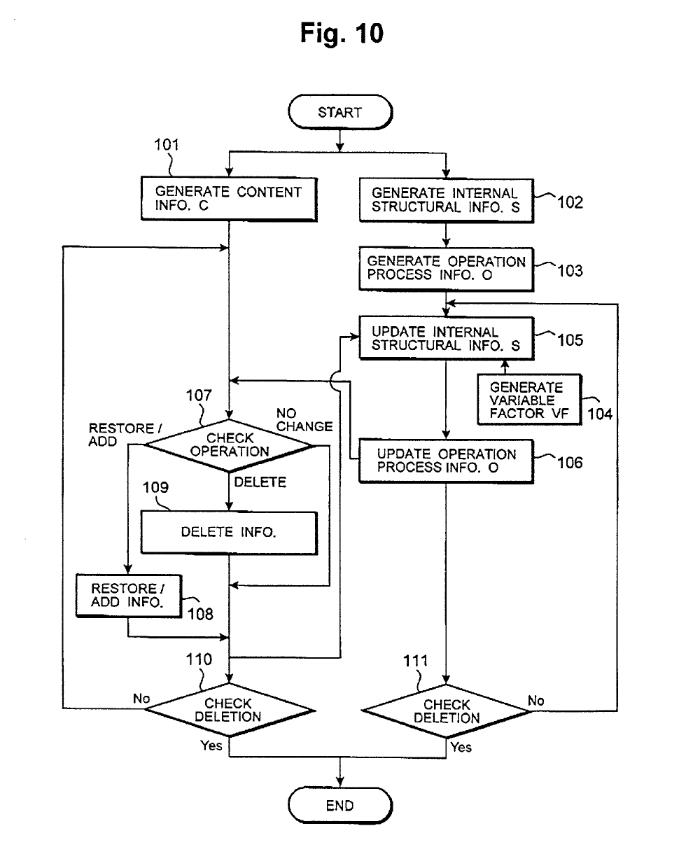

Next, with reference to the flow-chart of FIG. 10, the procedures according to the invention are explained.

In Step 101, the content information C of the layer-structured or non-layer-structured content which is used in the system of the invention is generated. At the same time, in Step 102, an internal structure of the content information C which is generated in Step 101 is analyzed and the internal structural information S is generated. In Step 103, based on the internal structural information S, the operation process information O with respect to the content information C is generated. In Step 104, information of the variable factor VF which causes the content information C to vary is generated. The variable factor VF gives an opportunity of the updating process of the internal structural information S which takes place in Step 105. Specifically, in Step 105, the internal structural information S is updated based on the operation process information O and the analysis of the variable factor VF generated in Step 104. In Step 106, the operation process information O is updated in accordance with the internal structural information S which has been updated in Step 105. Based upon the operation process information O which has been updated, the way how to process the content information C is determined. In Step 107, the analysis result in Step 106 is determined. If the result indicates the addition of the partial data, the process goes to the restoring and adding process in Step 108. If the result indicates the deletion of the information, the process goes to the partial data deleting process in Step 109. If there is no change in the result, the process goes to the content information deletion check process in Step 110.

If the determination result in Step 107 indicates the restoring and addition of the partial data, in Step 108, the restoration information or the adding information are obtained and the content information is restored or other content information is added. If the determination result in Step 107 indicates the deletion of the content information, the content information is reduced by the deletion of the partial data in Step 109.

In Steps 110 and 111, if the analysis result in Step 106 indicates the deletion of the content information, there takes place the deletion process of the content information. If the instructions of the deletion of the content information is given by the request from the user, such information is deleted in the same way.

If the given instructions are not for the deletion of the information, such information is again subjected to the analysis of the operation information and the updating process. After the determination of the result, the above procedures are repeated.

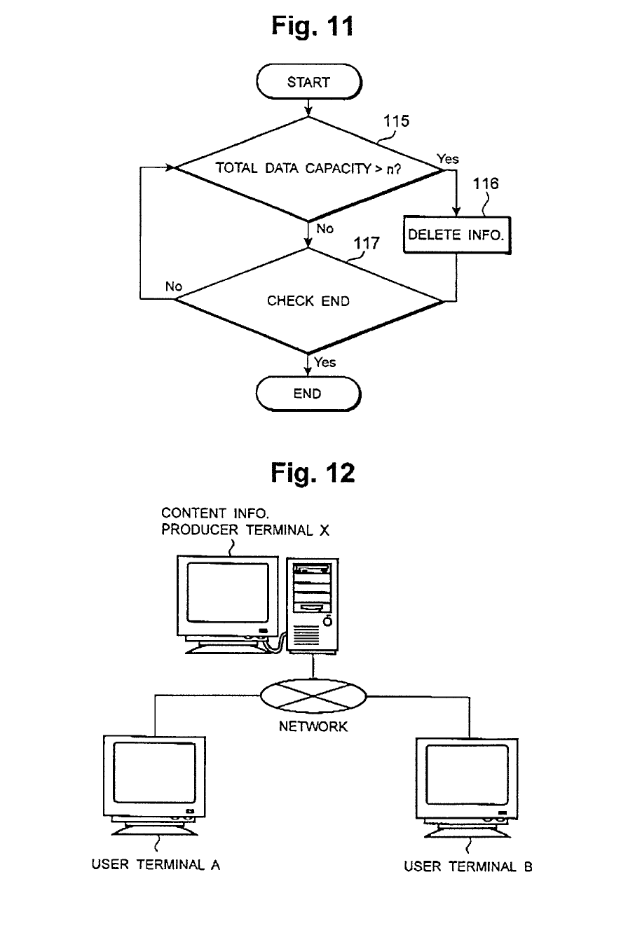

Next, with reference to the flow-chart of FIG. 11, the way how to control the increase and decrease of the data amount of the content information in the data-base is explained. In Step 115, the total data amount of the content information is determined whether it exceeds the specified amount n or not. If yes, the information is reduced by making the information deleting section operated in Step 116. In other cases, monitoring of the content information is continued through Step 117. Upon receipt of the end instructions of monitoring, the control of the content information is ended.

The system of the present invention is explained in more detail with reference to FIG. 12. In this illustrated embodiment, a content information producer terminal X and a plurality of user terminals A, B are connected in the network. In the content information producer terminal X, the content information C, the internal structural information S and the operation process information O are produced and, after they are integrated or combined, they are stored as the unified content information.

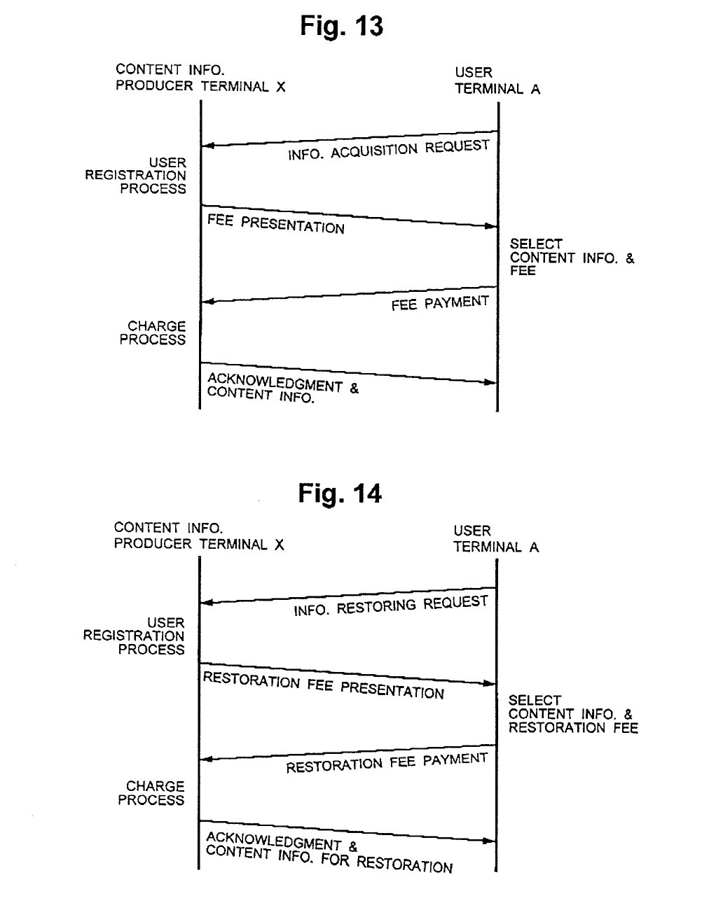

FIG. 13 shows the procedures for obtaining the content information in the system shown in FIG. 12. If the acquisition request for the content information is issued from the user terminal A to the content information producer terminal X, at the content information producer terminal X, the user registration or updating process for allowing the user A to utilize the stored content information is effected. The content information producer terminal X transmits the presentation of the fee for the content information to the user terminal A. Upon receipt of the fee presentation, at the user terminal A, the user A pays the presented fee electronically. Upon receipt of the fee payment information for the content information from the user terminal A, the content information producer terminal X transmits the acknowledging information to the user terminal A after the completion of the fee imposing process. Simultaneously, the content information producer terminal X transmits the relevant content information requested by the user A to the user terminal A.

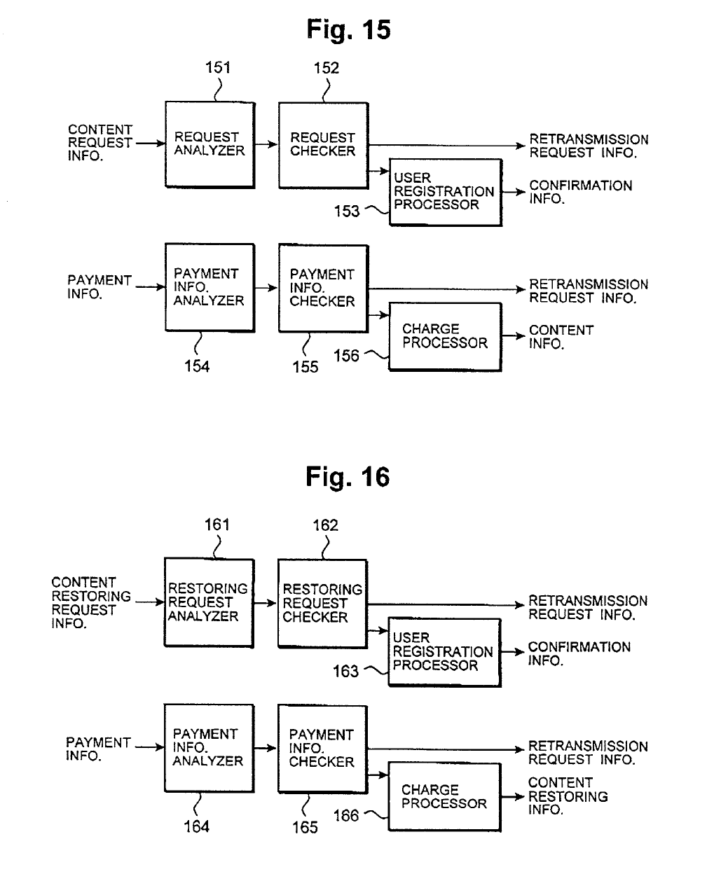

Hereunder, the content information acquisition process is explained in detail by referring to FIG. 15.

Where the content information acquisition request is transmitted from the user terminal A to the content information producer terminal X, the request information such as the user's identification number and the requested content is analyzed by a request analyzer 151. If the user's request is determined as satisfying the requirements by a request checker 152, the user is registered by a user registration processor 153 and the registration confirmation information is sent back to the user terminal A. If the acquisition of information is allowed by the request checker 152, the user registration processor 153 is operated. In other cases, the message for requesting the resending of the acquisition request is issued to the user A and the procedure returns to the initial state accordingly.

In the content information producer terminal X which has received from the user terminal A electronically the fee payment information for utilizing the content information, such fee payment information is analyzed by a payment information analyzer 154 and it is determined by a payment information checker 155 as to whether the correct fee has been paid or not. If it is determined that the correct fee has been paid, the fee imposing process for the content information with respect to the registered user is performed by a charge processor 156 and the relevant content information is transmitted to the user terminal A. If the fee payment information is determined as incorrect, the re-sending request is issued to the user terminal A and the procedure returns to the initial state. The above fee imposing process may well be performed after the transmission of the content information or performed after the updating of the information in the same way.

At the user terminal A, the received content information is stored in the external memory device and the user A is allowed to use the content information. In the user terminal A, monitoring of the variable factor with respect to the content information is conducted, and updating of the content information as well as updating of the internal structural information and the operation process information in accordance with the operation instruction information are conducted. In the case where the user wishes to utilize the content information whose partial data has been once deleted, after the restoration of the partial data, the user terminal A transmits to the content information producer terminal X the information restoring request.

As shown in FIG. 14, the content information producer terminal X which received the information restoring request for the reduced content information transmits to the user terminal A the presentation of restoration fee in response to the user's information restoring request. The user A which received the presentation of the content information restoration fee electronically pays the relevant fee.

Upon receipt of the information of the restoration fee payment for the content information, the content information producer X transmits the acknowledging information to the user terminal A and, then, transmits to the user A the partial data which is necessary for the restoration process after the preparation of the same from the stored content information.

The user terminal A which received the content information for restoring process analyzes the operation instruction information and performs the restoring process of the content information in accordance with the restoring request. Further, the internal structural information S and the operation process information O are updated. The user A is allowed to utilize the content information corresponding to the user's restoring request.

Thereafter, the user A can utilize the content information under the state wherein monitoring of the variable factor with respect to the operation information is continuously performed and the fee imposing process is effected repeatedly, if necessary, between the content information producer terminal X and the user A. It is needless to say that the content information can be used by the user terminal B in the same way as the user terminal A.

Now, the procedures for obtaining the content information for restoration process will be explained with reference to FIG. 16.

Where the content information restoring request is transmitted from the user terminal A to the content information producer terminal X, the request information such as the user's identification number, the requested content information and the relevant partial data of the content information is analyzed by a restoring request analyzer 161. If the user's request is determined as satisfying the requirements by a restoring request checker 162, the user is registered by a user registration processor 163 and the registration confirmation information is sent back to the user terminal A. If the user's request is determined as incorrect, the message for requesting the resending of the restoring request is issued to the user A and the procedure returns to the initial state accordingly.

At the content information producer terminal X which has received from the user terminal A the fee payment information relating to the restoration of the content information, the fee imposing procedure which is the same as in FIG. 15 is effected as shown in FIG. 16.

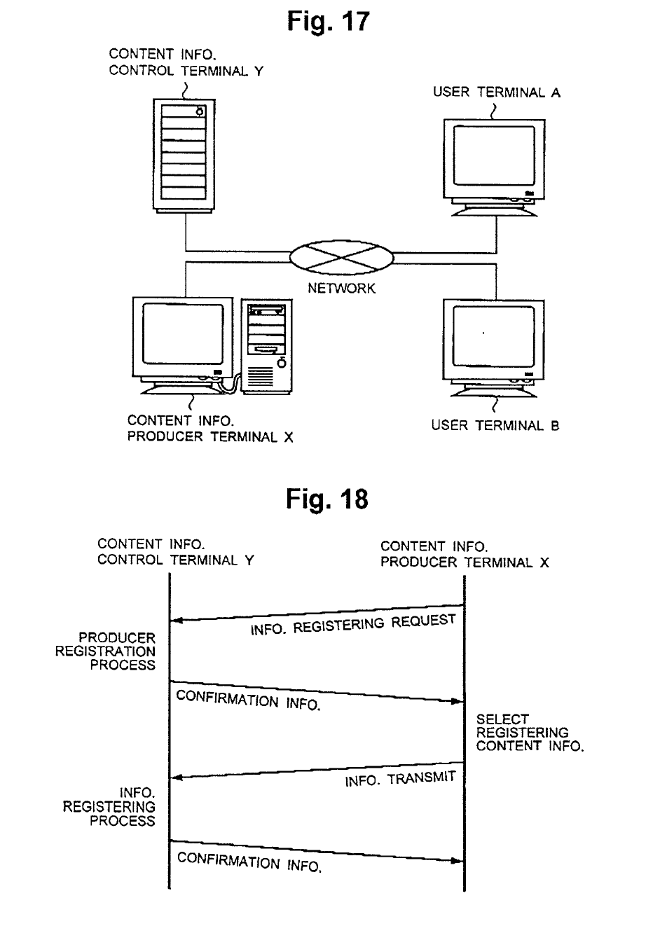

Next, another embodiment will be explained with reference to FIG. 17.

In the embodiment shown in FIG. 17, in addition to the content information producer terminal X and the user terminals A, B, a content information control terminal Y which controls or manages the content information is connected to the same network. In this embodiment, the content information producer terminal X registers in advance the content information in the content information control terminal Y, and the user makes an information acquisition request or an information restoring request to the content information control terminal Y, if necessary The content information control center Y performs centrally the delivering of the content information and the fee imposing procedure, and it has a function to feedback to the producer X the fee paid by the users A, B.

A detailed explanation is made with reference to FIG. 18. The content information producer terminal X issues to the content information control terminal Y a registration request for registering the relevant content information produced by the producer X. The content information control center Y performs the registration or updating procedure of the producer of the relevant content information and, then, it transmits to the content information producer terminal X the confirmation information relating to the producer registration procedure.

Upon receipt of such registration confirmation information, the content information producer terminal X transmits the selected content information to the content information control terminal Y. At the content information control terminal Y, such content information is accumulated or stored in the external memory device. The control center Y then transmits to the content information producer terminal X the confirmation message informing that the content information has been stored correctly.

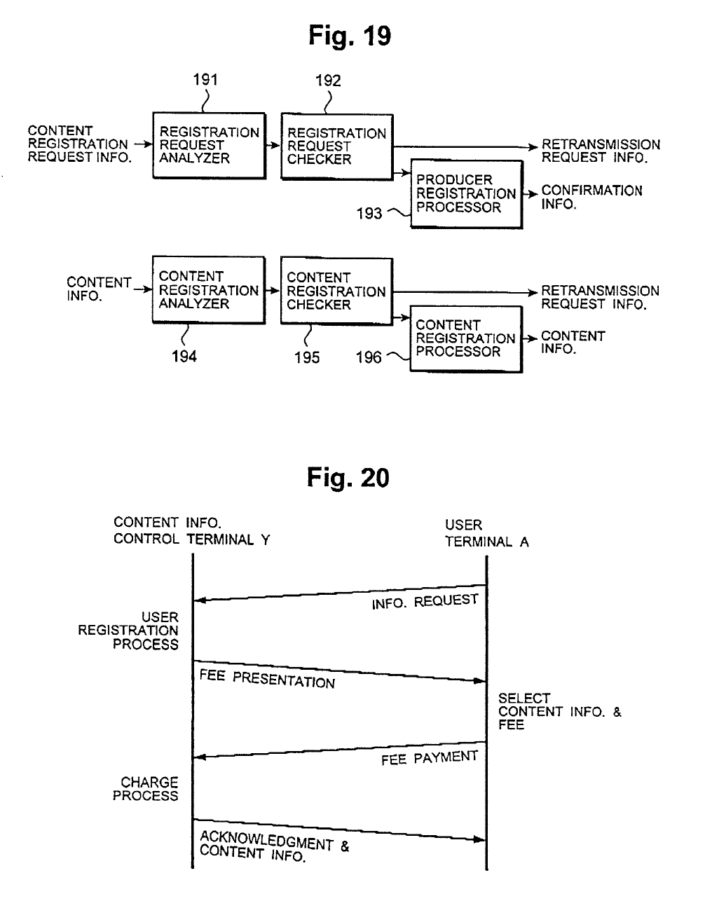

Here, the registering procedures of the content information producer and the content information are explained in detail with reference to FIG. 19.

Where the content information registration request issued from the content information producer terminal X is received by the content information control center Y, the request information such as the identification number of the registrant is analyzed by a registration request analyzer 191. If the registrant request is determined as satisfying the requirements by a registration request checker 192, the producer is registered by a producer registration processor 193 and the registration confirmation information is sent back to the producer terminal X. If the request is determined as incorrect by the registration request checker 192, the message for requesting the resending of the registration request is issued to the producer terminal X.

At the content information control center Y which has received the relevant content information from the content information producer terminal X, such content information is analyzed by a content registration analyzer 194 and it is determined by a content registration checker 195 as to whether the content information can be registered or stored correctly or not. If it is determined as yes, the relevant content information is registered in the data-base by a content registration processor 196. Then, the registration confirmation information is transmitted to the information producer terminal X. If the registration process is determined as incorrect, the message for requesting the resending of the content information registration request is issued to the content information producer terminal X.

Referring to FIG. 20, the flow of data between the content information control terminal Y and the user terminal A which takes place when the content information acquisition request is made is explained. When the request for acquisition of the content information is transmitted from the user terminal A to the content information control terminal Y, at the content information control terminal Y, the user registration or updating process is carried out for the user A to utilize the accumulated content information. Then, from the content information control terminal Y, presentation of the content information acquisition fee is transmitted to the user terminal A. On receiving the transmission, the user terminal A carries out electronic payment of the acquisition fee indicated. At the content information control terminal Y, the payment information of the acquisition fee is received from the user terminal A, the fee imposing process is conducted and, thereafter, the acknowledging information is transmitted to the user terminal A. From the content control terminal Y, the content information requested by the user A is transmitted to the user terminal A.

At the user terminal A, the content information received is stored in the external memory device. In this way, the user A can utilize such content information. At the user terminal A, the variable factor with respect to the content information recorded is monitored and, according to the operation information, the content information is updated and the operation information is also updated. Under the state where the content information has been reduced or deleted in the user's terminal, when the user desires to restore and use the updated content information, the restoration request for the updated content information is transmitted from the user terminal A to the content information control terminal Y.

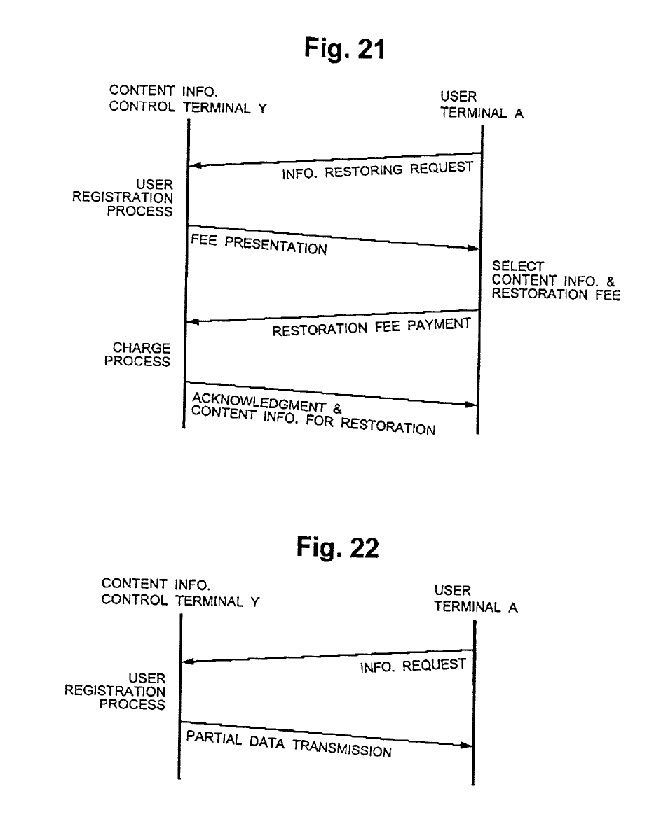

Referring to FIG. 21, the flow of data between the content information control terminal Y and the user terminal A when the content information restoring request is made is explained. Upon receiving the request for restoration of the content information, the content information control terminal Y transmits to the user terminal A the presentation of content information restoration fee. Then, the user A which has received the presentation of fee pays electronically the necessary restoration fee as shown. At the content information control terminal Y, upon receiving the restoration fee payment information, the fee imposing process is conducted and the acknowledging information is transmitted to the user terminal A. Then, after the drawing out a partial data necessary for restoring process from the recorded content information and the preparation of the content information for purposes of restoration, such content information requested by the user A is transmitted to the user terminal A from the content information control terminal Y.

At the user's terminal A which has received the content information for restoration purposes, the operation information of the content information is analyzed, and the content information for which the restoration request has been made is subjected to the restoration process. Also, the internal structural information S and the operation process information O are updated, and the user A can utilize the restored content information in accordance with the restoring request.

At the content information control terminal Y, the content information acquisition or restoration fees are summed up, and these fees are fed-back to the content information producer X.

Thereafter, the user A can utilize the content information under the state wherein monitoring of the variable factor with respect to the operation information is continuously performed and the fee imposing process is effected repeatedly, if necessary, between the content information control terminal Y and the user A.

Now, a further different embodiment of the invention is explained hereunder. This embodiment relates a system which is equipped with the control terminal Y and in which to the user terminal A a partial data of the content information has been transmitted in advance and, if the user A requests not only the partial data but also the data which exceeds the partial data, the restoration of the information and the fee imposing processes are sequentially performed. The configuration of the system is the same as one shown in FIG. 17.

The details of the system are explained with reference to FIG. 18. The content information producer X transmits a request that the content information prepared in advance be registered at the content information control terminal Y. At the content information control terminal Y, the registration of the content information or the updating process is conducted. Then, the acknowledging information on the content information registration process is transmitted to the content information producer terminal X.

The content information producer X who has received the acknowledging information on the content information producer registration process selects the content information to be registered and transmits it to the content information control terminal Y. Then, at the content information control terminal Y which has received the above content information, the information is stored in the external memory device and the acknowledging information of the content information registration is transmitted to the content information producer terminal X

Next, as shown in FIG. 22, when the acquisition request for the partial data of the content information is transmitted from the user terminal A to the content information control terminal Y, the user registration or updating process for the user A to utilize the accumulated content information is conducted at the content information control terminal Y.

Then, the partial data of the content information requested by the user A is transmitted to the user terminal A from the content information control terminal Y. Since the content information transmitted at this stage consists of the partial data as well as the internal structural information and the operation information to be utilized unitarily with the above partial data, the use of a part of the content information based on the partial data does not require the utilization fee.

The user terminal A causes the received content information to be stored in the external memory device, and this allows the user A to utilize the content information. When the user desires to use the entire information corresponding to the partial data or to use more content information by restoration, the restoring request is transmitted to the content information control terminal Y from the user terminal A.

As shown in FIG. 21, upon receiving the restoring request for the content information, the content information control terminal Y transmits to the user terminal A the presentation of content information utilization fees proportional to the amount of the restoration information. The user A having received the presentation of the content information utilization fees electronically pays the fees thus presented.

Upon receiving the restoration fee payment information for the content information, the content information control terminal Y transmits the acknowledging information to the user terminal A, and draws out the partial data necessary to restore the information from the stored content information, prepares the content information for restoration purposes and transmits it to the user terminal A.

The user terminal A having received the content information for restoration purposes analyzes the operation information of such information and performs the restoration process of the content information for which the restoring request was made. Further, the internal structural information and the operation information are also updated. In this way, the user A can utilize the content information in accordance with the request of the user A.

At the content information control terminal Y, the content information utilization fees are added up, and such fees are fed-back to the content information producer X.

Thereafter, the user A can utilize the content information under the state wherein monitoring of the variable factor with respect to the operation information is continuously performed and the fee imposing process is effected repeatedly, if necessary, between the content information control terminal Y and the user A.

As explained hereinabove, the system according to the invention comprises means for generating the content information such as the images or audio data which has a layer structure and which is unitarily processed with the internal structural information and the operation process information, and means for utilizing only the necessary portion of the content information by deleting or restoring the partial data of the content information generated by the means for generating the content information. The content information whose value becomes low can be automatically reduced or deleted, and such content information whose partial data has been once deleted can be restored, if desired, by newly obtaining the partial data which corresponds to the deleted partial data from the network. As a consequence, it has become possible to effectively utilize the hardware resources at the user side.

While the invention has been described in its preferred embodiments, it is to be understood that the words which have been used are words of description rather than limitation and that changes within the purview of the appended claims may be made without departing from the true scope of the invention as defined by the claims.

What is claimed is:

1. A multimedia information processing device in which content information, such as still image data, audio data, text data and movie image data, having non-layered structures, layered structures or structures in combination therewith is formed to have a layer structure, deleted, restored or added, said device comprising:
an internal structural information generator for generating internal structural information by analyzing internal structures of said content information having layered structures or non-layered structures; and
an operation process information generator for generating operation process information by analyzing editing and processing contents of said content information having layered structures or non-layered structures.

2. The multimedia information processing device according to claim 1, which further comprises an integrating means for integrating said content information, said internal structural information, and said operation process information.

3. The multimedia information processing device according to claim 2, which further comprises a separating means for separating the information integrated by said integrating means into said content information, said internal structural information, and said operation process information.

4. The multimedia information processing device according to claim 3, in which said separating means further separates operation instruction information which relates to operation instructions.

5. The multimedia information processing device according to claim 1, in which said internal structural information includes at least any one of layered structural information of said content information having the layered structure or non-layered structure, combination information of said content information having a plurality of non-layered structures, and structural combination information of said content information having the layered structure and non-layered structure.

6. The multimedia information processing device according to claim 1, in which said operation process information includes at least any one of a genre of said content information, a lapse of time from generating said content information, a service class of said content information, a system load of said content information, an information storage capacity of an external memory device, a network load, and a utilization frequency of said content information.

7. The multimedia information processing device according to claim 1, which further comprises:
an internal structural information checking means for checking said internal structural information;
an operation process information checking means for checking said operation process information;
a content information editing and processing means for deleting, restoring or adding a partial data of said content information based on results checked by said internal structural information checking means and said operation process information checking means;
an internal structural information analyzing and updating means for analyzing said internal structural information of said content information and updating said internal structural information; and
an operation process information analyzing and updating means for analyzing said operation process information of said content information and updating said operation process information.

8. The multimedia information processing device according to claim 7, which further comprises an integrating means for integrating the content information from said content information editing and processing means, the internal structural information from said internal structural information analyzing and updating means, and the operation process information from said operation process information analyzing and updating means.

9. The multimedia information processing device according to claim 7, which further comprises:
an operation instruction information checking means for checking operation instruction information of said content information; and
an operation instruction information analyzing and updating means for analyzing said operation instruction information and updating said operation instruction information,
said content information editing and processing means deleting, restoring or adding a partial data of said content information based on results checked by said internal structural information checking means, said operation process information checking means, and said operation instruction information checking means.

10. The multimedia information processing device according to claim 9, which further comprises an integrating means for integrating the content information from said content information editing and processing means, the internal structural information from said internal structural information analyzing and updating means, the operation process information from said operation process information analyzing and updating means, and the operation instruction information from said operation instruction information analyzing and updating means.

11. The multimedia information processing device according to claim 1, which further comprises a data capacity checking means for checking whether a total amount of a data capacity of said content information is within a range of a predetermined capacity, and in which, when said total amount is larger than said predetermined capacity, a partial data of said content information is deleted.

12. The multimedia information processing device according to claim 1, which further comprises:
a user checking means for checking whether a user is a registered one when said content information is utilized;
a user registration processing means for registering said user when said user checking means determines that said user has not been registered;
a fee presentation means for indicating fees in accordance with said content information;
a fee payment means for paying said fees indicated by said fee presentation means;
a payment information checking means for checking whether said fees paid by said fee payment means are proper;
a fee imposing process means for imposing said fees when said fee payment information checking means determines that said fees paid by said fee payment means are correct; and
an information transmitting means for transmitting said content information when said fee payment information checking means determines that said fees paid by said fee payment means are correct.

13. The multimedia information processing device according to claim 1, which further comprises:
a user checking means for checking whether a user is a registered one when a partial data deleted from said content information is utilized;
a user registration processing means for registering said user when said user checking means determines that said user has not been registered;
a fee presentation means for indicating fees in accordance with said partial data;
a fee payment means for paying said fees indicated by said fee presentation means;
a payment information checking means for checking whether said fees paid by said fee payment means are proper;
a fee imposing process means for imposing said fees when said fee payment information checking means determines that said fees paid by said fee payment means are correct; and
an information transmitting means for transmitting said partial data when said fee payment information checking means determines that said fees paid by said fee payment means are correct.

14. The multimedia information processing device according to claim 12, which further comprises:
a content information producer terminal for producing said content information;
a content information control terminal for registering said content information produced by said content information producer terminal; and
a user terminal used by said user,
said content information control terminal including said user checking means, said user registration processing means, said fee presentation means, said payment information checking means, said fee imposing process means, and said information transmitting means, and
said user terminal including said fee payment means.

15. The multimedia information processing device according to claim 13, which further comprises:
a content information producer terminal for producing said content information;
a content information control terminal for registering said content information produced by said content information producer terminal; and
a user terminal used by said user,
said content information control terminal including said user checking means, said user registration processing means, said fee presentation means, said payment information checking means, said fee imposing process means, and said information transmitting means, and
said user terminal including said fee payment means.
